(19) United States
(12) Patent Application Publication
(10) Pub. No.: US 2025/0103194 A1
(43) Pub. Date: Mar. 27, 2025

(54) METHOD AND APPARATUS, ELECTRONIC DEVICE, AND STORAGE MEDIUM FOR TASK PROCESSING

(71) Applicant: Beijing Youzhuju Network Technology Co., Ltd., Beijing (CN)

(72) Inventors: Qiusi WANG, Beijing (CN); Yi REN, Beijing (CN); Sai MA, Beijing (CN); Weizhi LIU, Beijing (CN); Hongxiang SHU, Beijing (CN); Lei YOU, Beijing (CN)

(21) Appl. No.: 18/974,620

(22) Filed: Dec. 9, 2024

(30) Foreign Application Priority Data
Jan. 29, 2024 (CN) 202410122523.7

(51) Int. Cl. G06F 3/0484; G06F 3/0482

(52) U.S. Cl. CPC G06F 3/0484; G06F 3/0482

(57) ABSTRACT

Embodiments of the present disclosure provide a method and apparatus, an electronic device, and a storage medium for task processing. The method is applied to a robot and includes: displaying at least one display control and an abnormality reporting control on a display screen of the robot, where the display control is configured to display task-associated information of a task to be processed; displaying an abnormal task selection page in response to a trigger operation for the abnormality reporting control, to determine a target abnormal task based on a trigger operation on the abnormal task selection page, where the abnormal task selection page includes the at least one display control; and sending task-associated information and abnormality information of the target abnormal task to a target terminal in response to a trigger operation of uploading the target abnormal task.

### CROSS-REFERENCE TO RELATED APPLICATION(S)

This application claims priority to Chinese Application No. 202410122523.7 filed Jan. 29, 2024, the disclosure of which is incorporated herein by reference in its entity.

### FIELD

Embodiments of the present disclosure relate to robot technologies, and in particular, to a method and apparatus, an electronic device, and a storage medium for task processing.

### BACKGROUND

With the rapid popularization of Internet technology and the continuous progress in artificial intelligence, robots have become the focus of attention in various industries.

In the related technologies, a robot is often used to process different tasks to be processed.

### SUMMARY

The present disclosure provides a method and apparatus, an electronic device, and a storage medium for task processing, to achieve the purpose of improving the efficiency in task processing.

In a first aspect, an embodiment of the present disclosure provides a method for task processing. The method is applied to a robot and includes:
displaying at least one display control and an abnormality reporting control on a display screen of the robot, where the display control is configured to display task-associated information of a task to be processed;
displaying an abnormal task selection page in response to a trigger operation for the abnormality reporting control, to determine a target abnormal task based on a trigger operation on the abnormal task selection page, wherein the abnormal task selection page includes the at least one display control; and
sending task-associated information and abnormality information of the target abnormal task to a target terminal in response to a trigger operation of uploading the target abnormal task,
wherein the abnormality information includes description information on an abnormality in the target abnormal task.

According to a second aspect, an embodiment of the present disclosure further provides an apparatus for task processing. The apparatus is configured in a robot and includes:
a control display module configured to display at least one display control and an abnormality reporting control on a display screen of the robot, where the display control is configured to display task-associated information of a task to be processed;
a target abnormal task determining module configured to display an abnormal task selection page in response to a trigger operation for the abnormality reporting control, to determine a target abnormal task based on a trigger operation on the abnormal task selection page, where the abnormal task selection page includes the at least one display control; and
an information sending module configured to send task-associated information and abnormality information of the target abnormal task to a target terminal in response to a trigger operation of uploading the target abnormal task,
wherein the abnormality information includes description information on an abnormality in the target abnormal task.

According to a third aspect, an embodiment of the present disclosure further provides an electronic device. The electronic device includes:
at least one processor; and
a memory communicatively connected to the at least one processor, where
the memory stores a computer program executable by the at least one processor, and the computer program, when executed by the at least one processor, causes the at least one processor to perform the method for task processing according to any of the embodiments of the present disclosure.

According to a fourth aspect, an embodiment of the present disclosure further provides a computer-readable storage medium storing computer instructions that, when executed by a processor, cause the processor to perform the method for task processing according to any of the embodiments of the present disclosure to be implemented.

According to the embodiment of the present disclosure, the at least one display control and the abnormality reporting control are displayed on the display screen of the robot, where the display control is configured to display the task-associated information of the task to be processed; then, with the abnormality reporting control, the abnormal task selection page can be displayed in response to the trigger operation for the abnormality reporting control in the case of the abnormality in the process of performing the task to be processed; then, the task to be processed that needs to performed by the robot is displayed through the abnormal task selection page, and the target abnormal task is determined based on the trigger operation on the abnormal task selection page, where the abnormal task selection page includes the at least one display control; and further, the task-associated information and abnormality information of the target abnormal task are sent to the target terminal in response to the trigger operation of uploading the target abnormal task, so that the task-associated information and the abnormality information are reported to the target terminal by the robot, which makes it possible to make a response to the abnormality in a timely manner, accelerate the progress in processing the task to be processed, and achieve the effect of improving the efficiency in task processing.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a method for task processing according to an embodiment of the present disclosure;

FIG. 2 is a schematic diagram of an abnormal task selection page according to an embodiment of the present disclosure;

FIG. 3 is a schematic flowchart of a method for task processing according to an embodiment of the present disclosure;

FIG. 4 is a schematic diagram of a task display page according to an embodiment of the present disclosure;

FIG. 5 is a schematic diagram of a display interface for an abnormality cause to be selected according to an embodiment of the present disclosure;

FIG. 6 is a schematic flowchart of a method for delivery task processing according to an embodiment of the present disclosure;

FIG. 7 is a schematic diagram of a structure of an apparatus for task processing according to an embodiment of the present disclosure; and

FIG. 8 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an alternative but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

The related technologies have at least the following technical problems: Due to a difference between different tasks to be processed, an abnormality may occur in the process of performing the tasks to be processed, which causes an interruption in the process of processing the tasks to be processed, and a failure to respond to the abnormality in a timely manner, thereby affecting the processing progress and efficiency of the robot for the tasks to be processed.

Before the technical solutions are described, an exemplary description may be given to the application scenario. The technical solutions may be applied to a scenario of processing a task to be processed with an abnormality in the case that a robot performs a task to be processed for delivering an object to be delivered. For example, the technical solutions may be applied to a station delivery scenario, a food delivery scenario, and other scenarios, in which the robot delivers objects to be delivered between different buildings, floors, or rooms. For example, in the station delivery scenario, a station may be used as a delivery end, and the object to be delivered may be stored in the robot at the delivery end, thereby generating a task to be processed for delivering the object to be delivered; and the task to be processed is performed by the robot so as to deliver the object to be delivered to a pickup end. Alternatively, the technical solutions may be applied to an item storage scenario in which the robot is used to store an item for users. For example, in the item storage scenario, obtaining an item to be stored and storing the item to be stored may be used as a task to be processed, which is performed by the robot. According to the technical solutions, when an abnormality occurs in the process of performing the task to be processed, the robot sends task-associated information and abnormality information of a target abnormal task to a target terminal, so that a response to the abnormality is made in a timely manner, a progress in processing the task to be processed is accelerated, and the efficiency in task processing for the task to be processed is improved.

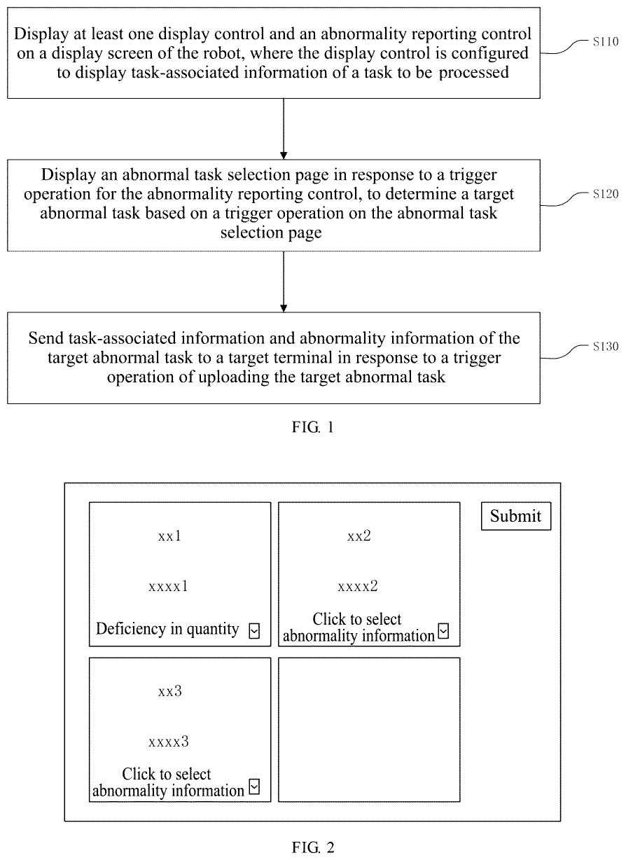

FIG. 1 is a schematic flowchart of a method for task processing according to an embodiment of the present disclosure. This embodiment of the present disclosure is applicable to a case that when there is an abnormality in a task to be processed, a robot reports a target abnormal task to a target terminal. The method may be performed by an apparatus for task processing. The apparatus may be implemented in the form of software and/or hardware. Alternatively, the apparatus may be implemented by an electronic device, which may be a mobile terminal, a PC, a server, or the like.

As shown in FIG. 1, the method is applied to a robot and includes the following steps.

S110: Display at least one display control and an abnormality reporting control on a display screen of the robot, and the display control is configured to display task-associated information of a task to be processed.

It should be noted that the robot disclosed in this solution is configured to perform the task to be processed. For example, in the station delivery scenario, the task to be processed is a delivery task for delivering an object to be delivered. In order to better display a situation of processing the task to be processed, a display screen may be configured on the robot to implement visual display of task information of the task to be processed through the display screen. Further, in order to improve the convenience of performing the task to be processed, the display screen may be a touch display screen.

In this embodiment, the at least one display control is displayed on the display screen, and the display control is configured to display the task-associated information of the task to be processed. The task-associated information includes a task identifier, and a user identifier of at least one user associated with the task to be processed, and the task-associated information is used to distinguish tasks to be processed from each other. Alternatively, each task to be processed is associated with at least one user. For example, when the task to be processed is a delivery task, the task to be processed is associated with at least one pickup user; and when the task to be processed is an item storage task, the task to be processed is associated with at least one item storage user and item obtaining user.

In practical application, a number of display controls is related to a number of tasks to be processed that correspond to the robot. For example, the tasks to be processed include an express delivery task, a food delivery task, etc. The display controls are in a one-to-one correspondence with the tasks to be processed, with each display control displaying task-associated information of one task to be processed; alternatively, the display screen includes one display control for displaying task-associated information of all tasks to be processed that are performed by the robot.

In this embodiment, an abnormality reporting control is displayed on the display screen of the robot, and the abnormality reporting control is configured to obtain abnormality information of an abnormal task to be processed, such as a task identifier, an abnormality cause, and other information of the abnormal task to be processed. In a specific implementation, one abnormality reporting control may be set for each display control, so that when an abnormality occurs in a task to be processed that corresponds to the display control, the abnormal task to be processed is reported through the abnormality reporting control corresponding to the display control. Alternatively, one abnormality reporting control is displayed on the display screen, and when an abnormality occurs in any task to be processed, the abnormality may be reported by triggering the abnormality reporting control.

For clear and detailed description of the display control on the display screen, reference may be made to FIG. 2. FIG. 2 illustrates a display control on a robot display screen by taking the station delivery scenario as an example. In the station delivery scenario, the robot includes at least one compartment for accommodating the tasks to be processed. FIG. 2 shows four compartments, among which three compartments correspond to the tasks to be processed, and one compartment is idle. Each task to be processed is displayed through one display control, and on the display control corresponding to the task to be processed, a compartment identifier, task-associated information, and an abnormality reporting control are displayed. As shown in FIG. 2, the compartment identifier may be represented as “xx1”, “xx2”, and “xx3”, and the task-associated information may be represented as “xxxx1”, “xxxx2”, and “xxxx3”. The display screen further includes a “Click to select abnormality information” control as the abnormality reporting control, and abnormality information may be generated by triggering a drop-down control corresponding to the “Click to select abnormality information”. For a task to be processed whose abnormality cause has been determined, the abnormality information, for example “Deficiency in number”, may be directly displayed on the display control. The display screen may further include a “Submit” control for abnormality reporting.

S120: Display an abnormal task selection page in response to a trigger operation for the abnormality reporting control, to determine a target abnormal task based on a trigger operation on the abnormal task selection page.

In this embodiment, the abnormality reporting control may be of at least one type of a button, an edit box, a selection control, and a drop-down control. Accordingly, depending on different types of the abnormality reporting control, the trigger operation for the abnormality reporting control may be a click operation, an input operation, a selection operation, etc. In practical application, in response to the trigger operation for the abnormality reporting control, the abnormal task selection page is displayed, and task-associated information of at least one task to be processed that is received by the robot is displayed through the abnormal task selection page.

In a specific implementation, the trigger operation on the abnormal task selection page may be a trigger operation for any control on the abnormal task selection page; and the target abnormal task is determined by the trigger operation on the abnormal task selection page. It should be noted that the target abnormal task is a task that the robot cannot continue processing, for example, a task that does not support robot processing, or a task with errors in task-associated information.

In a practical application, the abnormal task selection page includes at least one control, and the target abnormal task is determined through a response to a trigger operation for the control. For example, the abnormal task selection page contains an abnormal task input box, and the target abnormal task may be determined by inputting task-associated information of the abnormal task to be processed into the abnormal task input box; alternatively, the abnormal task selection page contains at least one display control, which is configured to display the task-associated information of the task to be processed, and the target abnormal task may be determined from the tasks to be processed based on the trigger operation for the display control.

In this embodiment, the abnormal task selection page includes the at least one display control, and the task-associated information displayed on the display control; and the display control on the abnormal task selection page further includes an abnormality cause selection sub-control, where the abnormality cause selection sub-control, after being triggered, displays at least one abnormality cause to be selected and an abnormality cause editing control.

For ease of viewing, the at least one display control located on the abnormal task selection page has the same layout as the at least one display control displayed on the display screen. Alternatively, on the abnormal task selection page, one corresponding display control may be set for each task to be processed that is assigned to the robot in order to comprehensively display task-associated information of the task to be processed. By displaying the display control on the abnormal task selection page, the task-associated information of the task to be processed is clearly and intuitively displayed, so that it is convenient for the user to accurately and quickly select the target abnormal task.

In this embodiment, the abnormality cause selection sub-control is configured to obtain abnormality information of the target abnormal task; and the abnormality information includes description information on an abnormality in the target abnormal task, such as description information on an abnormality cause, description information on an abnormality severity level, and description information on an abnormality type of the target abnormal task. For example, in the station delivery scenario, the description information on the abnormality cause may include item loss, deficiency in number of items, item information incompleteness, and item overweight. The description information on the abnormality severity level may include a minor abnormality, a medium abnormality, and a severe abnormality; and the description information on the abnormality type may include an abnormality in an object to be processed, and an abnormality in the task-associated information, etc.

Alternatively, the abnormal task selection page includes at least one abnormality cause selection sub-control. For example, each display control corresponds to one abnormality cause selection sub-control; alternatively, the abnormal task selection page contains only one abnormality cause selection sub-control, so as to obtain the abnormality information of the target abnormal task after the target abnormal task is determined.

It should be noted that after being triggered, the abnormality cause selection sub-control displays the at least one abnormality cause to be selected and the abnormality cause editing control. Specifically, the abnormality cause to be selected may be configured to be selected, and the abnormality information of the target abnormal task is determined based on the selected abnormality cause to be selected. The abnormality cause editing control is configured for entering edited text, and the abnormality information is determined based on the edited text in the abnormality cause editing control.

In this embodiment, the task-associated information of the task to be processed may clearly and intuitively displayed, so that it is convenient for the user to accurately and quickly select the target abnormal task. In addition, the abnormality cause selection sub-control is set on the abnormal task selection page, so that the abnormality information of the target abnormal task is obtained based on the abnormality cause selection sub-control, thereby improving the convenience in the process of processing the target abnormal task.

In practical application, an implementation of determining the target abnormal task based on the trigger operation on the abnormal task selection page includes determining the target abnormal task based on the trigger operation for the display control on the abnormal task selection page. When detecting that the display control on the abnormal task selection page is triggered, a task to be processed that corresponds to task-associated information displayed by the display control may be determined as the target abnormal task.

Further, after the target abnormal task is determined, abnormality information corresponding to the target abnormal task may be obtained based on a trigger operation for the abnormality cause selection sub-control. Specifically, the manner of obtaining the abnormality information corresponding to the target abnormal task includes displaying the at least one abnormality cause to be selected and the abnormality cause editing control in response to the trigger operation for the abnormality cause selection sub-control; and determining the abnormality information based on a trigger operation for the abnormality cause to be selected and/or the edited text in the abnormality cause editing control.

In a specific implementation, an implementation of determining the target abnormal task based on the trigger operation on the abnormal task selection page may also be: displaying the at least one abnormality cause to be selected and the abnormality cause editing control in response to the trigger operation for the abnormality cause selection sub-control, to determine the abnormality information based on the trigger operation for the abnormality cause to be selected and/or the edited text in the abnormality cause editing control; and determining a task to be processed that corresponds to the triggered abnormality cause selection sub-control as the target abnormal task.

Alternatively, the abnormality cause selection sub-control corresponds to the task to be processed. When the abnormality cause selection sub-control is triggered, a corresponding task to be processed may be determined, and the task to be processed that corresponds to the triggered abnormality cause selection sub-control is determined as the target abnormal task. Specifically, on the abnormal task selection page, there may be a plurality of abnormality cause selection sub-controls being triggered, so as to quickly determine a plurality of target abnormal tasks.

In addition, the abnormality information corresponding to the target abnormal task may be determined through the trigger operation for the abnormality cause selection sub-control. Specifically, in response to the trigger operation for the abnormality cause selection sub-control, the at least one abnormality cause to be selected may be displayed, and the selected abnormality cause to be selected is determined as the abnormality information.

It should be noted that, for each abnormality cause selection sub-control, the same abnormality cause to be selected may be preset for display; alternatively, depending on different tasks to be processed that correspond to the abnormality cause selection sub-controls, different abnormality causes to be selected may be set for display, so that the abnormality causes to be selected that match the tasks to be processed are adaptively provided with respect to different tasks that are processed.

Further, after the abnormality cause selection sub-control is triggered, the abnormality cause editing control may be displayed, and after the abnormality cause editing control is triggered, the edited text in the abnormality cause editing control may be obtained, and information corresponding to the edited text is determined as the abnormality information.

In this embodiment, the abnormality information is determined based on the trigger operation for the abnormality cause to be selected and/or the edited text in the abnormality cause editing control, thereby improving the diversity of the manner of obtaining the abnormality information; the convenience of determining the abnormality information is improved by providing the abnormality cause to be selected in advance; and when none of the abnormality causes to be selected can accurately reflect the abnormality information, the abnormality cause editing control is further provided, which is helpful in obtaining the abnormality information flexibly and accurately.

S130: Send task-associated information and abnormality information of the target abnormal task to a target terminal in response to a trigger operation of uploading the target abnormal task, wherein the abnormality information includes description information on an abnormality in the target abnormal task.

In a specific implementation, uploading of the target abnormal task may be triggered by means of a voice instruction, a gesture instruction, etc. Alternatively, an abnormality submit control may further be set on the abnormal task selection page, and when the abnormality submit control is clicked, the uploading of the target abnormal task is triggered.

In order to handle the target abnormal task in a timely manner, the task-associated information and the abnormality information of the determined target abnormal task may be sent to the target terminal in response to the trigger operation of uploading the target abnormal task, so as to complete an upload operation of the target abnormal task. The target terminal may be a terminal for processing an abnormal task, for example, the target terminal may be an operation and maintenance terminal configured to perform maintenance on robot operation.

According to the technical solution of the embodiment of the present disclosure, the at least one display control and the abnormality reporting control are displayed on the display screen of the robot, and the display control is configured to display the task-associated information of the task to be processed; then, with the abnormality reporting control, the abnormal task selection page can be displayed in response to the trigger operation for the abnormality reporting control in the case of the abnormality in the process of performing the task to be processed; then, the task to be processed that needs to be performed by the robot is displayed through the abnormal task selection page, and the target abnormal task is determined based on the trigger operation on the abnormal task selection page, where the abnormal task selection page includes the at least one display control; and further, the task-associated information and abnormality information of the target abnormal task are sent to the target terminal in response to the trigger operation of uploading the target abnormal task, so that the task-associated information and the abnormality information are reported to the target terminal by the robot, which makes it possible to make a response to the abnormality in a timely manner, accelerate the progress in processing the task to be processed, and achieve the effect of improving the efficiency in task processing.

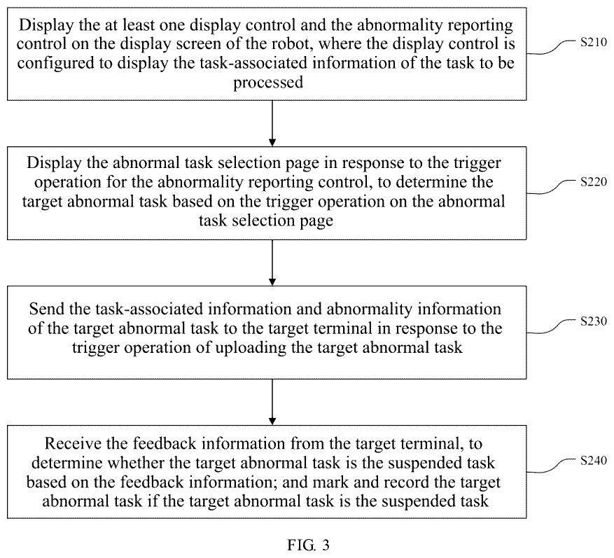

FIG. 3 is a schematic flowchart of a method for task processing according to an embodiment of the present disclosure. On the basis of the foregoing embodiments, feedback information from the target terminal may be received after the abnormality information is determined, and if the target abnormal task is a suspended task, the target abnormal task is marked and recorded. Explanations of the terms identical or corresponding to those in the above embodiments are not repeated herein.

As shown in FIG. 3, the method includes the following steps.

S210: Display the at least one display control and the abnormality reporting control on the display screen of the robot, and the display control is configured to display the task-associated information of the task to be processed.

Alternatively, the abnormal task selection page includes the at least one display control, and the task-associated information displayed on the display control; and the display control on the abnormal task selection page further includes the abnormality cause selection sub-control, and the abnormality cause selection sub-control, after being triggered, displays the at least one abnormality cause to be selected and the abnormality cause editing control.

S220: Display the abnormal task selection page in response to the trigger operation for the abnormality reporting control, to determine the target abnormal task based on the trigger operation on the abnormal task selection page.

In this embodiment, the manner of determining the target abnormal task further includes: displaying a task display page in response to a trigger operation for display control on the abnormal task selection page, and the task display page is configured to display at least one subtask to be processed that is associated with a task to be reported, and the task to be reported is a task to be processed that corresponds to the triggered display control; and determining the target abnormal task in response to a trigger operation for the at least one subtask to be processed that is presented on the task display page.

It should be noted that each task to be processed may include at least one subtask to be processed; and accordingly, each piece of task-associated information may include at least one piece of subtask-associated information. For example, when the task to be processed is a delivery task, there may be a plurality of objects to be delivered that correspond to the task to be processed, and each object to be delivered may correspond to one subtask to be processed. The subtask-associated information may be an object identifier of the object to be delivered.

In a specific implementation, a task display interface corresponding to the display control may be displayed when it is detected that the display control on the abnormal task selection page is triggered. It should be noted that the task display interface may correspond to the at least one display control, and it may also be understood as that the task display interface may present a subtask to be processed that corresponds to the at least one display control. For example, in the case that the task display interfaces are in a one-to-one correspondence with the display controls, if a display control 1 corresponds to a task to be reported 1, then after the display control 1 is triggered, a task display interface 1 is displayed, and at least one subtask to be processed that is associated with the task to be reported 1 is displayed on the task display interface 1.

Furthermore, if it is detected that the at least one subtask to be processed that is presented on the task display page is triggered, each of the subtasks to be processed that are triggered may be determined as the target abnormal task.

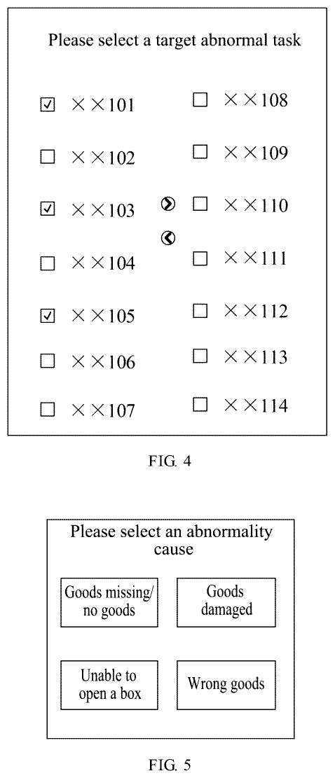

FIG. 4 is a schematic diagram of a task display page according to an embodiment of the present disclosure. As shown in FIG. 4, identifiers of subtasks to be processed that are associated with a task to be reported “xx1” are displayed on the task display page. The task display page also displays a check box corresponding to each subtask to be processed, and the check box is configured for selection of the target abnormal task from the subtasks to be processed. As shown in FIG. 4, subtasks to be processed “xx101”, “xx103”, and “xx105” are selected, indicating that the subtasks to be processed “xx101”, “xx103”, and “xx105” are the target abnormal tasks. Further, on the task display page, a page changing operation may be performed through page changing controls [symbol] and [symbol] to display all the subtasks to be processed.

According to this embodiment, by displaying the task display page, the information of the subtasks to be processed is clearly and completely displayed to the user, and the target abnormal task is quickly determined based on the trigger operation for the at least one subtask to be processed.

In practical application, the method further includes displaying the at least one abnormality cause to be selected, to determine the abnormality information of the target abnormal task based on the trigger operation for the at least one abnormality cause to be selected.

Specifically, the target abnormal task may include the at least one task to be processed and/or subtask to be processed. In the case where the target abnormal task is the at least one subtask to be processed, the at least one abnormality cause to be selected may be displayed on the task display page or on the display screen of the robot. If there is one target abnormal task, the abnormality cause to be selected for the target abnormal task may be directly displayed. If there are a plurality of target abnormal tasks, the at least one abnormality cause to be selected may be displayed for each target abnormal task. In a specific implementation, after it is detected that a corresponding abnormality cause to be selected is triggered, abnormality information may be generated for a corresponding target abnormal task based on a correspondence between the abnormality cause to be selected and the target abnormal task.

A schematic diagram of the display interface for the abnormality cause to be selected is shown in FIG. 5, and each abnormality cause to be selected corresponds to one check box, so that the abnormality information is determined through a selection operation for the check box. As shown in FIG. 5, the abnormality cause to be selected may include “goods missing/no goods”, “goods damaged”, “unable to open a box”, and “wrong goods”, and it may be possible to select only one check box, or to perform the selection operation for a plurality of check boxes simultaneously.

In this embodiment, after the trigger operation for the at least one subtask to be processed, a reason why the subtask to be processed is the abnormal task is intuitively and clearly displayed to the user by displaying the abnormality cause to be selected, so as to facilitate selection of the user.

S230: Send the task-associated information and abnormality information of the target abnormal task to the target terminal in response to the trigger operation of uploading the target abnormal task.

In order to enable the user to clearly and intuitively view the abnormality information of the target abnormal task, the method further includes determining a display control that corresponds to the target abnormal task on the display screen, and displaying the abnormality information at a preset display position in the display control.

It should be noted that the display control is configured to display the task-associated information of the at least one task to be processed, that is, the display control corresponds to the at least one task to be processed. After the target abnormal task is determined, the display control that corresponds to the information of the target abnormal task on the display screen may be determined, and the abnormality information of the target abnormal task may be displayed at the preset display position in the display control. The preset display position may be an empty position in the display control.

In practical application, when displaying abnormality information, the abnormality information may be displayed in the forms of text or picture. Specifically, the display manner of the abnormality information may be determined based on a dimension of a display range of the preset display position.

In this embodiment, by displaying the abnormality information at the preset display position in the display control, the task-associated information and abnormality information of the target abnormal task can be simultaneously displayed in the display control, so that it is convenient for the user to view the information of the target abnormal task intuitively and clearly.

S240: Receive the feedback information from the target terminal to determine whether the target abnormal task is the suspended task based on the feedback information; and mark and record the target abnormal task if the target abnormal task is the suspended task.

The feedback information is configured to reflect a task attribute of the target abnormal task, and the task attribute includes the suspended task and a non-suspended task. For example, in the station delivery scenario, if the object to be delivered is not picked up normally by a pickup end after being delivered to a destination, then a task to be delivered corresponding to the object to be delivered is the suspended task.

In a specific implementation, the target terminal pre-stores a task attribute of the task to be processed that is assigned to the robot. After receiving the task-associated information and abnormality information of the target abnormal task, the target terminal may determine the task attribute of the target abnormal task based on the task-associated information of the target abnormal task, generate the feedback information based on the task attribute, and send the feedback information to the robot. The robot parses the feedback information. If it is determined that the target abnormal task is the suspended task, which indicates that the target abnormal task requires processing through cooperation with the user, the robot marks and records the target abnormal task, to wait for the user to handle the target abnormal task. For example, in the station delivery scenario, if the target abnormal task is the suspended task, then the suspended task is marked and recorded. When it is detected that the object to be delivered that corresponds to the suspended task has been picked up, the record of the suspended task is cleared.

Furthermore, if it is determined that the target abnormal task is the non-suspended task, the task-associated information and abnormality information of the target abnormal task may be sent to a task scheduling system, so that the task scheduling system reassigns and processes the target abnormal task, thereby improving the efficiency in task processing.

In this embodiment, the target abnormal task is divided into the suspended task and the non-suspended task, for which different processing manners are provided respectively, so that the target abnormal task can be accurately and effectively processed in a timely manner according to the task attribute of the target abnormal task, thereby improving the efficiency in task processing.

The embodiments corresponding to the method for task processing are described in detail above. In order to make those skilled in the art further understand the technical solution of the method, a specific description is given below in combination with the station delivery scenario.

In practical application, the robot includes at least one compartment configured to accommodate the task to be processed, and the task to be processed includes at least one subtask to be processed, and the subtask to be processed corresponds to an object to be delivered; and the robot further includes a display screen including at least one display control, and the display control is configured to display task-associated information of the task to be processed that is accommodated in the compartment, and the task-associated information includes a task identifier, and a user identifier of at least one user associated with the task to be processed.

Each compartment on the robot corresponds to one task to be processed. Each task to be processed corresponds to at least one object to be delivered. The object to be delivered includes an item to be delivered, such as a document, food, and clothes. That is, each compartment may be configured to store the at least one object to be delivered. The display screen on the robot may be a touch display screen, and the display control on the display screen corresponds to the task to be processed.

In this embodiment, the compartment is provided on the robot to allow for storage of the object to be delivered, and the delivery of the object to be delivered is achieved by completing a task processing process.

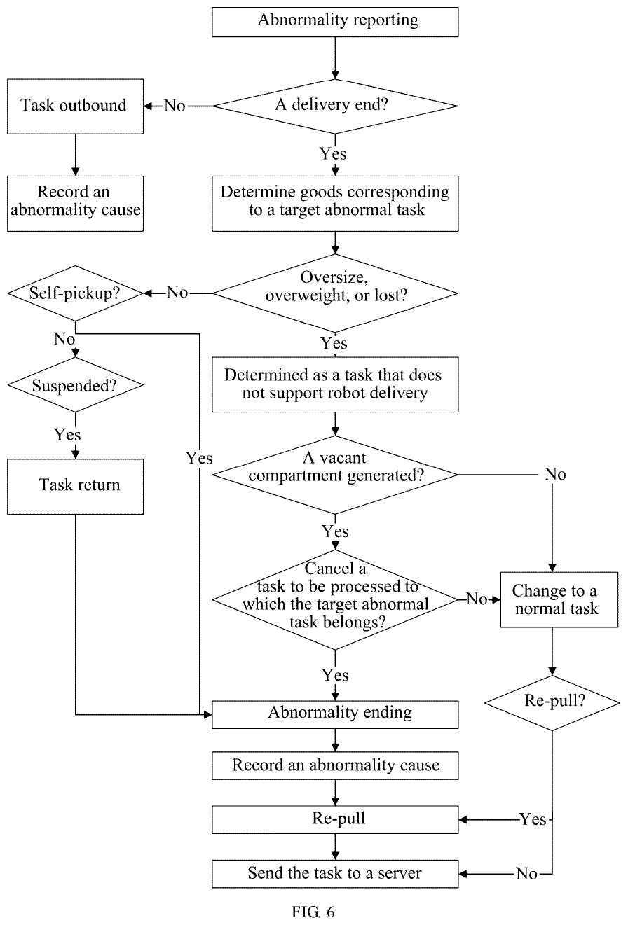

In the station delivery scenario of this embodiment, the task processing process is shown in FIG. 6. Specifically, after the robot initiates abnormality reporting, it may be detected whether the abnormality is generated by a delivery end. If the abnormality is not generated by the delivery end, the target abnormal task may be outbound, and an abnormality cause may be recorded; or if the abnormality is generated by the delivery end, goods corresponding to the target abnormal task may be determined, and it is determined whether the abnormality cause is oversize, overweight, or goods loss. If it is determined that one of them is the abnormality cause, then the target abnormal task is determined as a task that does not support robot delivery and is marked, to prevent it from being reselected to be delivered by the robot by the user who places a second order; or if it is determined that none of them is the abnormality cause, it may be determined whether the target abnormal task is a task that needs self-pickup, and if it is a task that needs self-pickup, the target abnormal task is marked as abnormality ending; or if it is not a task that needs self-pickup, then it is determined whether the target abnormal task is the suspended task, and if the target abnormal task is the suspended task, then the target abnormal task is returned, and marked as abnormality ending; or if it is determined that the target abnormal task is not the non-suspended task, the task-associated information of the target abnormal task may be sent to the task scheduling system, so as to reassign the target abnormal task.

In this embodiment, the method further includes determining a task to be processed to which the target abnormal task belongs based on a server, and determining whether to pull a new task based on target carrying information and current carrying information of a compartment corresponding to the task to be processed; and if pulling a new task, generating a task pull instruction and sending the task pull instruction to a task scheduling system, so that the task scheduling system pulls a new task based on the task pull instruction and distributes the new task to the robot, in order for the compartment of the robot to carry the new task.

The server may be the target terminal or other terminals that establish a communication connection with the target terminal. The task-associated information and abnormality information of the target abnormal task are obtained through the server. It should be noted that the target abnormal task may be the at least one task to be processed or the at least one subtask to be processed.

In a specific implementation, the task-associated information of the target abnormal task may be determined by the server, and a task to be processed that matches the task-associated information of the target abnormal task is used as the task to be processed to which the target abnormal task belongs. For example, if the task-associated information of the target abnormal task is “xx1”, a task to be processed that has the task-associated information “xx1” is determined as the task to be processed to which the target abnormal task belongs.

In order to improve the working efficiency of the robot, when a target abnormal task occurs, it may be determined whether a compartment corresponding to the task to be processed to which the target abnormal task belongs is still capable of carrying a new task, so as to improve the utilization of the compartment. Specifically, the target carrying information and current carrying information of the compartment corresponding to the target abnormal task may be obtained. The target carrying information is used to reflect at least one of a maximum number, a maximum weight, and a maximum volume of objects to be delivered that the compartment can carry. The current carrying information is used to reflect at least one of an actual number, an actual weight, and an actual volume of objects to be delivered that the compartment is currently carrying.

In a specific implementation, if the target carrying information and the current carrying information meet a preset condition, it is determined that a new task can be pulled; or if the preset condition is not met, it is determined that no new task is to be pulled. Specifically, the preset condition may include at least one of the following conditions: the actual number that the compartment is carrying being less than the maximum number that the compartment can carry; the actual weight that the compartment is carrying being less than the maximum weight that the compartment can carry; and the actual volume that the compartment is carrying being less than the maximum volume that the compartment can carry.

If a new task is to be pulled, task information of the newly pulled task may be determined based on the current carrying information and the target carrying information, and a task pull instruction is generated based on the task information and then sent to the task scheduling system. The task information includes at least one of the number, volume, and weight of the newly pulled task. After receiving the task pull instruction, the task scheduling system may determine a task to be processed that matches the task information as a new task, and distribute the new task to the robot, for the compartment of the robot to carry the new task.

If no new task is to be pulled, compartment closing information is generated, and the compartment closing information is sent to the robot to perform a compartment closing operation.

Furthermore, after the target abnormal task is determined as the task that does not support robot delivery, whether there is a vacant compartment generated in the robot may be determined. The specific process is shown in FIG. 6. If there is a vacant compartment generated, then whether to cancel the task to be processed to which the target abnormal task belongs is determined, that is, whether a number of the target abnormal tasks is equal to a total number of tasks corresponding to the tasks to be processed to which the target abnormal tasks belong. If they are equal, the task to be processed to which the target abnormal task belongs is canceled, the target abnormal task is marked as abnormality ending, the abnormality cause is recorded, and a new order is re-pulled. If the number of the target abnormal tasks is less than the total number of tasks, or if there is no vacant compartment generated, the target abnormal task may be changed to a normal task and it may be determined whether it is necessary to re-pull the normal task, and if it is necessary to re-pull the normal task, task-associated information of the normal task is sent to the task scheduling system for re-pull; or if it is unnecessary to re-pull the normal task, the normal task may be sent to the server normally, and the server is informed of information such as the reason why the task cannot be delivered.

In this embodiment, after the target abnormal task is determined, a new task may be pulled for the compartment based on compartment information, thereby improving the utilization of the compartment and the working efficiency of the robot.

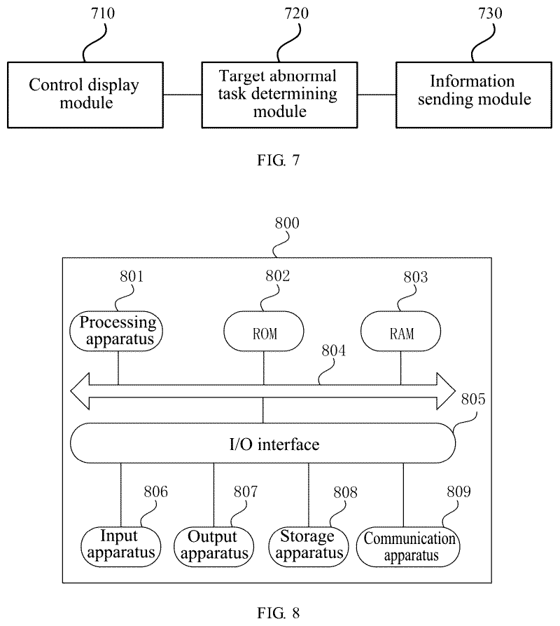

FIG. 7 is a schematic diagram of a structure of an apparatus for task processing according to an embodiment of the present disclosure. As shown in FIG. 7, the apparatus includes: a control display module 710, a target abnormal task determining module 720, and an information sending module 730.

The control display module 710 is configured to display at least one display control and an abnormality reporting control on a display screen of a robot, where the display control is configured to display task-associated information of a task to be processed;
the target abnormal task determining module 720 is configured to display an abnormal task selection page in response to a trigger operation for the abnormality reporting control, to determine a target abnormal task based on a trigger operation on the abnormal task selection page, and the abnormal task selection page includes the at least one display control; and
the information sending module 730 configured to send task-associated information and abnormality information of the target abnormal task to a target terminal in response to a trigger operation of uploading the target abnormal task,
and the abnormality information includes description information on an abnormality in the target abnormal task.

On the basis of the above alternative technical solutions, alternatively, the abnormal task selection page includes the at least one display control and the task-associated information displayed on the display control; and
the display control on the abnormal task selection page further includes an abnormality cause selection sub-control, wherein the abnormality cause selection sub-control, after being triggered, displays at least one abnormality cause to be selected and an abnormality cause editing control.

On the basis of the above alternative technical solutions, alternatively, the target abnormal task determining module 720 includes:
an abnormality information determining sub-module configured to display the at least one abnormality cause to be selected and the abnormality cause editing control in response to the trigger operation for the abnormality cause selection sub-control, to determine the abnormality information based on the trigger operation for the abnormality cause to be selected and/or edited text in the abnormality cause editing control; and
a first target abnormal task determining sub-module configured to determine a task to be processed that corresponds to the triggered abnormality cause selection sub-control as the target abnormal task.

On the basis of the above alternative technical solutions, alternatively, the apparatus further includes:
a task display page display sub-module configured to display a task display page in response to a trigger operation for the display control on the abnormal task selection page, and the task display page is configured to present at least one subtask to be processed that is associated with a task to be reported, and the task to be reported is a task to be processed that corresponds to the triggered display control; and
a second target abnormal task determining sub-module configured to determine the target abnormal task in response to a trigger operation for the at least one subtask to be processed that is presented on the task display page.

On the basis of the above alternative technical solutions, alternatively, the apparatus further includes:

a cause trigger sub-module configured to display the at least one abnormality cause to be selected, to determine the abnormality information of the target abnormal task based on the trigger operation for the at least one abnormality cause to be selected.

On the basis of the above alternative technical solutions, alternatively, the apparatus further includes:

an abnormality information display module configured to determine a display control that corresponds to the target abnormal task on the display screen, and display the abnormality information at a preset display position in the display control.

On the basis of the above alternative technical solutions, alternatively, the robot includes at least one compartment configured to accommodate the task to be processed, and the task to be processed includes at least one subtask to be processed, and the subtask to be processed corresponds to an object to be delivered; and the robot further includes a display screen including at least one display control, and the display control is configured to display task-associated information of the task to be processed that is accommodated in the compartment, and the task-associated information includes a task identifier, and a user identifier of at least one user associated with the task to be processed.

On the basis of the above alternative technical solutions, alternatively, the apparatus further includes:
a feedback information receiving module configured to receive feedback information from the target terminal, to determine whether the target abnormal task is a suspended task based on the feedback information after the task-associated information and abnormality information of the target abnormal task are sent to the target terminal; and
an abnormality recording module configured to mark and record the target abnormal task if the target abnormal task is a suspended task.

On the basis of the above alternative technical solutions, alternatively, the apparatus further includes:
a to-be-processed task determining module configured to determine a task to be processed to which the target abnormal task belongs based on a server, and determine whether to pull a new task based on target carrying information and current carrying information of a compartment corresponding to the task to be processed; and
a task distribution module configured to generate a task pull instruction and send the task pull instruction to a task scheduling system if a new task is to be pulled, so that the task scheduling system pulls a new task based on the task pull instruction and distributes the new task to the robot, in order for the compartment of the robot to carry the new task.

According to the technical solution provided in the embodiment of the present disclosure, the at least one display control and the abnormality reporting control are displayed on the display screen of the robot, and the display control is configured to display the task-associated information of the task to be processed; then, with the abnormality reporting control, the abnormal task selection page may be displayed in response to the trigger operation for the abnormality reporting control in the case of the abnormality in the process of performing the task to be processed; then, the task to be processed that needs to be performed by the robot is displayed through the abnormal task selection page, and the target abnormal task is determined based on the trigger operation on the abnormal task selection page, where the abnormal task selection page includes the at least one display control; and further, the task-associated information and abnormality information of the target abnormal task are sent to the target terminal in response to the trigger operation of uploading the target abnormal task, so that the task-associated information and the abnormality information are reported to the target terminal by the robot, which makes it possible to make a response to the abnormality in a timely manner, accelerate the progress in processing the task to be processed, and achieve the effect of improving the efficiency in task processing.

The apparatus for task processing according to an embodiment of the present disclosure can perform the method for task processing according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 8 is a schematic diagram of a structure of an electronic device according to an embodiment of the present disclosure. Reference is made to FIG. 8 below, which is a schematic diagram of a structure of an electronic device (such as a terminal device or a server in FIG. 8) 800 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (e.g., a central processing unit or a graphics processing unit) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 809, installed from the storage apparatus 808, or installed from the ROM 802. When the computer program is executed by the processing apparatus 801, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to an embodiment of the present disclosure and the method for task processing according to the above embodiments belong to the same concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the method for task processing according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
The above computer-readable medium carries one or more programs that, when executed by the electronic device, cause the electronic device to: display at least one display control and an abnormality reporting control on a display screen of a robot, where the display control is configured to display task-associated information of a task to be processed; display an abnormal task selection page in response to a trigger operation for the abnormality reporting control, to determine a target abnormal task based on a trigger operation on the abnormal task selection page, where the abnormal task selection page includes the at least one display control;
and send task-associated information and abnormality information of the target abnormal task to a target terminal in response to a trigger operation of uploading the target abnormal task, and the abnormality information includes description information on an abnormality in the target abnormal task.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for task processing, wherein the method is applied to a robot and comprises:
displaying at least one display control and an abnormality reporting control on a display screen of the robot, wherein the display control is configured to display task-associated information of a task to be processed;
displaying an abnormal task selection page in response to a trigger operation for the abnormality reporting control to determine a target abnormal task based on a trigger operation on the abnormal task selection page, wherein the abnormal task selection page comprises the at least one display control; and
sending task-associated information and abnormality information of the target abnormal task to a target terminal in response to a trigger operation of uploading the target abnormal task,
wherein the abnormality information comprises description information on an abnormality in the target abnormal task.

2. The method according to claim 1, wherein the abnormal task selection page comprises the at least one display control, and the task-associated information displayed on the display control; and
the display control on the abnormal task selection page further comprises an abnormality cause selection sub-control, wherein the abnormality cause selection sub-control, after being triggered, displays at least one abnormality cause to be selected and an abnormality cause editing control.

3. The method according to claim 2, wherein the determining a target abnormal task based on a trigger operation on the abnormal task selection page comprises:
displaying the at least one abnormality cause to be selected and the abnormality cause editing control in response to a trigger operation for the abnormality cause selection sub-control to determine the abnormality information based on a trigger operation for the abnormality cause to be selected and/or edited text in the abnormality cause editing control; and
determining a task to be processed that corresponds to the triggered abnormality cause selection sub-control as the target abnormal task.

4. The method according to claim 2, wherein the method further comprises:
displaying a task display page in response to a trigger operation for the display control on the abnormal task selection page, wherein the task display page is configured to present at least one subtask to be processed that is associated with a task to be reported, and the task to be reported is a task to be processed that corresponds to the triggered display control; and
determining the target abnormal task in response to a trigger operation for the at least one subtask to be processed that is presented on the task display page.

5. The method according to claim 4, wherein the method further comprises:
displaying the at least one abnormality cause to be selected to determine the abnormality information of the target abnormal task based on the trigger operation for the at least one abnormality cause to be selected.

6. The method according to claim 1, wherein the method further comprises:
determining a display control that corresponds to the target abnormal task on the display screen, and displaying the abnormality information at a preset display position in the display control.

7. The method according to claim 1, wherein the robot comprises at least one compartment configured to accommodate the task to be processed, wherein the task to be processed comprises at least one subtask to be processed, and the subtask to be processed corresponds to an object to be delivered; and
the robot further comprises the display screen comprising the at least one display control, wherein the display control is configured to display task-associated information of the task to be processed that is accommodated in the compartment, and the task-associated information comprises a task identifier, and a user identifier of at least one user associated with the task to be processed.

8. The method according to claim 1, wherein after the sending task-associated information and abnormality information of the target abnormal task to a target terminal, the method further comprises:
receiving feedback information from the target terminal to determine whether the target abnormal task is a suspended task based on the feedback information; and
marking and recording the target abnormal task in response to the target abnormal task being a suspended task.

9. The method according to claim 1, wherein the method further comprises:
determining a task to be processed to which the target abnormal task belongs based on a server, and determining whether to pull a new task based on target carrying information and current carrying information of a compartment corresponding to the task to be processed; and
in response to pulling a new task, generating a task pull instruction, sending the task pull instruction to a task scheduling system, so that the task scheduling system pulls a new task based on the task pull instruction and distributes the new task to the robot, to cause the compartment of the robot to carry the new task.

10. An electronic device, comprising:
one or more processors; and
a storage apparatus configured to store one or more programs, wherein
the one or more programs, when executed by the one or more processors, cause the one or more processors to:
display at least one display control and an abnormality reporting control on a display screen of the robot, wherein the display control is configured to display task-associated information of a task to be processed;
display an abnormal task selection page in response to a trigger operation for the abnormality reporting control to determine a target abnormal task based on a trigger operation on the abnormal task selection page, wherein the abnormal task selection page comprises the at least one display control; and
send task-associated information and abnormality information of the target abnormal task to a target terminal in response to a trigger operation of uploading the target abnormal task,
wherein the abnormality information comprises description information on an abnormality in the target abnormal task.

11. The device according to claim 10, wherein the abnormal task selection page comprises the at least one display control, and the task-associated information displayed on the display control; and
the display control on the abnormal task selection page further comprises an abnormality cause selection sub-control, wherein the abnormality cause selection sub-control, after being triggered, displays at least one abnormality cause to be selected and an abnormality cause editing control.

12. The device according to claim 11, wherein the one or more programs causing the one or more processors to determine a target abnormal task based on a trigger operation on the abnormal task selection page comprise instruction to:
display the at least one abnormality cause to be selected and the abnormality cause editing control in response to a trigger operation for the abnormality cause selection sub-control to determine the abnormality information based on a trigger operation for the abnormality cause to be selected and/or edited text in the abnormality cause editing control; and
determine a task to be processed that corresponds to the triggered abnormality cause selection sub-control as the target abnormal task.

13. The device according to claim 11, wherein the one or more programs further causes the one or more processors to:
display a task display page in response to a trigger operation for the display control on the abnormal task selection page, wherein the task display page is configured to present at least one subtask to be processed that is associated with a task to be reported, and the task to be reported is a task to be processed that corresponds to the triggered display control; and
determine the target abnormal task in response to a trigger operation for the at least one subtask to be processed that is presented on the task display page.

14. The device according to claim 13, wherein the one or more programs further causes the one or more processors to:
display the at least one abnormality cause to be selected to determine the abnormality information of the target abnormal task based on the trigger operation for the at least one abnormality cause to be selected.

15. The device according to claim 10, wherein the one or more programs further causes the one or more processors to:
determine a display control that corresponds to the target abnormal task on the display screen, and display the abnormality information at a preset display position in the display control.

16. The device according to claim 10, wherein the robot comprises at least one compartment configured to accommodate the task to be processed, wherein the task to be processed comprises at least one subtask to be processed, and the subtask to be processed corresponds to an object to be delivered; and
the robot further comprises the display screen comprising the at least one display control, wherein the display control is configured to display task-associated information of the task to be processed that is accommodated in the compartment, and the task-associated information comprises a task identifier, and a user identifier of at least one user associated with the task to be processed.

17. The device according to claim 10, wherein after the sending task-associated information and abnormality information of the target abnormal task to a target terminal, the one or more programs further causes the one or more processors to:
receive feedback information from the target terminal to determine whether the target abnormal task is a suspended task based on the feedback information; and
mark and record the target abnormal task in response to the target abnormal task being a suspended task.

18. The device according to claim 10, wherein t the one or more programs further causes the one or more processors to:
determine a task to be processed to which the target abnormal task belongs based on a server, and determine whether to pull a new task based on target carrying information and current carrying information of a compartment corresponding to the task to be processed; and
in response to pulling a new task, generating a task pull instruction, send the task pull instruction to a task scheduling system, so that the task scheduling system pulls a new task based on the task pull instruction and distributes the new task to the robot, to cause the compartment of the robot to carry the new task.

19. A non-transitory storage medium containing computer-executable instructions, wherein the computer-executable instructions, when executed by a computer processor, cause the computer processor to:
display at least one display control and an abnormality reporting control on a display screen of the robot, wherein the display control is configured to display task-associated information of a task to be processed;
display an abnormal task selection page in response to a trigger operation for the abnormality reporting control to determine a target abnormal task based on a trigger operation on the abnormal task selection page, wherein the abnormal task selection page comprises the at least one display control;
send task-associated information and abnormality information of the target abnormal task to a target terminal in response to a trigger operation of uploading the target abnormal task, and
wherein the abnormality information comprises description information on an abnormality in the target abnormal task.

20. The medium according to claim 19, wherein the abnormal task selection page comprises the at least one display control, and the task-associated information displayed on the display control; and
the display control on the abnormal task selection page further comprises an abnormality cause selection sub-control, wherein the abnormality cause selection sub-control, after being triggered, displays at least one abnormality cause to be selected and an abnormality cause editing control.
